(19) United States
(12) Patent Application Publication
(10) Pub. No.: US 2005/0244788 A1
(43) Pub. Date: Nov. 3, 2005

(54) PLASTIC TIP SYSTEM

(76) Inventor: James Feine, Bellaire, TX (US)

Correspondence Address: LUNDEEN & DICKINSON, LLP, PO BOX 131144, HOUSTON, TX, 77219-1144, US

(21) Appl. No.: 11/160,971

(22) Filed: Jul. 18, 2005

Related U.S. Application Data
(63) Continuation-in-part of application No. 10/065,161, filed on Sep. 23, 2002.

(51) Int. Cl. A61C 3/03

(52) U.S. Cl. 433/165; 433/119

(57) ABSTRACT

A pre-packaged, sterilized, single-use dental scaler tip, to be supplied to dental professionals, is used with an insert for an ultrasonic dental scaler. The single-use tip is employed for maintenance and preventive care for patients with titanium and other dental implants. The tip is packaged individually and sterilized by gas or irradiation, only to be removed after purchase, such as by the dental professional just before use on a patient. Upon completion of the patient care, the tips are preferably discarded and the dental insert is autoclaved or otherwise sterilized.

This invention is a continuation-in-part of my earlier copending application U.S. Ser. No. 10/065,161, filed Sep. 23, 2002.

### FIELD OF THE INVENTION

This invention relates to ultrasonic dental scalers, and more particularly, to a system and a method for providing individually packaged, disposable plastic tips for dental scalers for cleaning dental implants.

### BACKGROUND OF THE INVENTION

Dental implants are structures that are permanently engaged in the mouth of a dental patient. Dental implants usually provide an anchor against which one or more replacement teeth or bridges are engaged. Shaped like screws, posts, blades, and other structures, dental implants can be endosseous, inserted in to the jaw bone, transosseous, inserted through the jaw bone, or subperiosteal, placed above the jaw bone.

In addition to the variety of shapes and methods of engagement, dental implants are produced using many different materials. The materials are selected for their tolerability within the human body as well as their ability to integrate into living bone. Materials including Vitallium, aluminum oxide, commercially pure (CP) titanium, and titanium alloys are familiar dental implant materials. Recently, CP titanium and titanium alloys have been favored for their successful bone integration and their strength.

As with the teeth and gums, dental implants require maintenance, including brushing, flossing, and routine dental checkups. Calcium and other deposits attach to titanium implants. Traditional dental scalers employing metal-based tips, whether hand-held or ultrasonic, tend to scratch titanium implants. Thus, for cleaning of titanium implants, non-metallic tips would be preferred.

Ultrasonic dental tools such as dental scalers are well known and commonly used in hygienics, periodontal and other dental procedures. Ultrasonic dental tools usually come with a handgrip connected by a cable to water and electrical controls, and a replaceable insert having a magnetostrictive element, a velocity transducer, and a tip.

The ultrasonic scalers generally include a generator that electrically induces the scaling tip to vibrate at a very high rate. An alternating current is passed through an induction coil in a handpiece that induces vibration of the magnetostrictive element of an insert in the handpiece. The vibration is transmitted to the tip by a velocity transducer on the end of the magnetostrictive element. The vibration may cause the tip to move elliptically, in a curved linear fashion, or in a “figure eight” pattern.

Because of the high rate of tip vibration, the high-speed ultrasonic scalers generate a significant amount of heat. Accordingly, ultrasonic scalers operate with a water jet in the tip. The water cools the magnetostrictive element and the tip, as well as the tooth or dental implant being treated, while the scaler operates.

The nature of ultrasonics generally requires matching the tip with the transducer stack and generator frequency so that the end of the tip corresponds to a node of maximum vibration, whereas the connection of the tip to the transducer stack (especially where the tip is removable from the insert) must correspond to an antinode where there is little or no vibration which would otherwise generate heat and ultimately result in a failure of the connection. Since changing the length, tip geometry or the operating frequency will change the location of the nodes, and of the antinodes, the interchangeability of the tips and/or inserts between manufacturers is problematic.

These tools, especially the insert portions thereof that come in contact with the patient, need to be sterilized, usually by autoclaving between procedures. The insert is typically removed from the handpiece for autoclaving between procedures. Depending on the model, the tip and/or magnetostrictive element may be removable from the velocity transducer.

The autoclave sterilization of plastic-coated tips is problematic. Autoclaving is a sterilization technique in which objects are water-steamed at 250° F. under pressure for fifteen minutes. Autoclaving works very well for implements that are metallic. However, heat-sensitive materials, such as many plastics, tend to be denatured or destroyed after one or more sterilizations using autoclaving. Although other techniques for sterilization are known, dental offices most commonly employ autoclaving as the sole sterilization technique.

Plastic-containing tips used with ultrasonic dental scalers tend to deform or otherwise deteriorate after only a few sterilizations. Since ultrasonic scalers are carefully designed to provide a maximum vibration at the tip, any deformity of the tip can adversely affect operation. Further, deformation can render the tip ineffective at appropriately engaging with the surface of the tooth or the titanium implant. Delamination of a plastic coating or covering on the base metal of the tip can be disadvantageous, particularly when it occurs while treating a patient. Plastic-coated and plastic-covered tips can also be considered costly, as they are replaced more often than all-metal tips.

A disposable tip for a periodontal probe is known from U.S. Pat. No. 5,178,537 to Currie, which includes a measuring tine, and a connecting shaft, connected by a two-portion intermediate section extending at obtuse angles. The measuring tine of the periodontal probe tip is elongated, thin, and flexible. Periodontal probe tips are not vibrated and are thus not designed with a geometry suitable for use with an ultrasonic dental scaler in general, nor in any particular manufacturer's scaler unit. For example, a dental scaling procedure may not be effective if the distal end of the tip is not located at a node of maximum vibration, or the connection of the probe tip to the handpiece may fail catastrophically if it is not located at an antinode with no or minimal vibration.

Thus, there is a need to provide ultrasonic dental scaler tips to avoid scratching titanium implants in a cost-effective manner.

### SUMMARY OF THE INVENTION

The present invention overcomes the problems noted above by disclosing prepackaged, sterilized, single-use disposable plastic tips for a dental scaler insert. Also disclosed is a method for supplying a disposable tip to a dental practitioner for use with an insert for a handpiece in an ultrasonic dental scaler unit. The method includes the steps of identifying one or more specific make and model of ultrasonic dental handpiece insert for which the tips will be supplied: forming or acquiring a plurality of polymeric tips for the one or more specific ultrasonic dental scalers, the tips each having a proximal and distal end, the proximal end removably attachable to the distal end of the specific insert; individually packaging the tip in a biologically sealed, sterilizable container; sterilizing the tip in the package; and distributing the sterilized, packaged tips to dental practitioners having at least one or more of the specific make and model of ultrasonic dental scaler handpiece insert.

In one embodiment, the method further discloses coupling the individually packaged, sterilized, polymeric tip with other individually packaged, sterilized, polymeric tips and packaging the coupled tips as a quantity package. In another embodiment, dental practitioners are provided with the ultrasonic dental scaler handpiece insert. Optionally, the packaged tips can be labeled to identify the one or more specific make and model of ultrasonic dental scaler handpiece insert with which the tip can be used. In addition, a list of specific make and model of ultrasonic dental scaler handpiece inserts and tips can be published. Preferably, the proximal end of the tip corresponds to an antinode, and the distal end corresponds to a node of maximum vibration when the tip is attached to the one or more specific make and model of ultrasonic dental scaler handpiece insert.

A method for using a disposable tip with an ultrasonic dental scaler is disclosed, in which a sterilized, monolithic polymeric ultrasonic dental scaler tip in a sealed container is supplied to a dental practitioner as previously described, the dental practitioner is provided with the identification of at least one or more specific make and model with which the tip can be used, instructions are provided for removing the tip from the sterilized package, the tip is attached to a dental insert corresponding to the one or more specific make and model of ultrasonic dental scaler handpiece, the insert is secured in the dental scaler, the dental scaler is then operated to clean titanium implants, and thereafter disposed of.

A method of using a disposable tip with an ultrasonic dental scaler is also disclosed, in which a make and model of an ultrasonic dental scaler unit comprising a handpiece with an insert with a distal end adapted for removably attaching a dental scaling tip is acquired, a plurality of sterilized prepackaged, sterilized, single-use monolithic polymeric ultrasonic dental scaler tips are acquired, a sterilized polymeric tip is removed from a sealed container, the sterilized polymeric tip is attached to a dental insert, the sterilized polymeric tip is operated in a patient, wherein the patient has titanium implants, and the sterilized polymeric tip is disposed of.

In one embodiment, the method further discloses the pre-packaged tip is labeled for use with a specific make and model of ultrasonic dental scaler. Another embodiment discloses the tip is removed from the insert, the insert is sterilized, the removal, attachment, and operation is repeated with another disposable tip, the sterilized insert, and a new patient.

### BRIEF DESCRIPTION OF THE DRAWINGS

FIG. 1 is a diagram of a disposable tip according to one embodiment of the invention;

FIG. 2 is a flow diagram depicting a method for supplying the disposable tip of FIG. 1 according to one embodiment of the invention; and

FIG. 3 is a block diagram depicting a method for using the disposable tip of FIG. 1 according to one embodiment of the invention.

### DESCRIPTION OF THE INVENTION

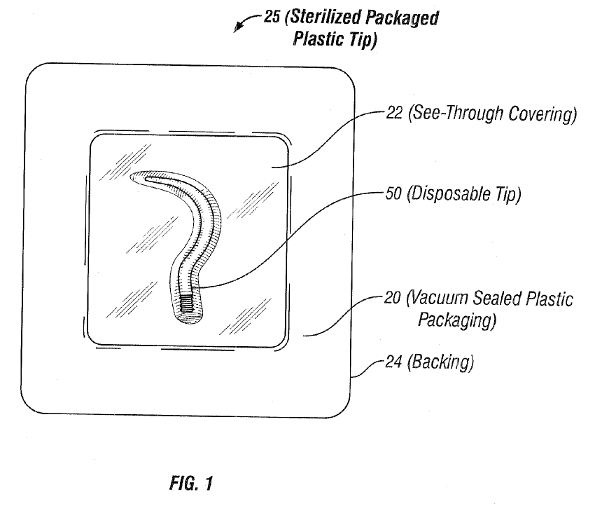

With reference to FIGS. 1-3, wherein like numerals are used to reference like parts, the present method employs a pre-packaged, sterilized, single-use dental scaler tip, to be supplied to dental professionals, for use with an ultrasonic dental scaler. The single-use tip is employed for maintenance and preventive care for patients with titanium and other dental implants. The tip is sterilized prior to packaging, then is vacuum-packed, only to be removed after purchase, such as by the dental professional just before use on a patient. Upon completion of the patient care, the tips are preferably discarded.

Thus, according to the embodiments described herein, a method of supplying dental practitioners with pre-sterilized, individually packaged, single-use plastic tips, for use with ultrasonic dental scalers, is disclosed. The tips are intended for a single use by the dental professional, that is, use in a single dental patient during a single patient visit.

In FIG. 1, a sterilized, packaged plastic tip 25 is depicted, according to one embodiment. The sterilized, packaged plastic tip 25 includes a disposable tip 50 encased in a package 20. In one embodiment, the package 20 is a vacuum-sealed plastic packaging, such as packaging used to enclose hypodermic needles, medical instruments, and the like. The plastic packaging 20 comprises a see-through covering 22, such as a polyolefin polymer or copolymer, and a backing 24, either or both of which are preferably gas permeable.

In one embodiment, the backing comprises a rigid material, such as cardboard, which is treated such that the vacuum-sealed plastic packaging is suitably sterile. In a second embodiment, the backing 24 is not a rigid material, but instead is composed of a material substantially similar to the see-through covering 22. The backing 24 may itself be see-through or may be composed of a more opaque material. In either case, the covering 22 and/or the backing 24 facilitate sterilization after assembly, e.g. either or both should be gas permeable if gas sterilization will be used, or transparent to gamma radiation if this is the sterilization technique of choice.

The disposable tip 50 is designed for ease of use. In a preferred embodiment, the methods described herein are useful in connection with the production of polymeric rather than metallic tips. The polymeric tips may be composite tips, comprising multiple compounds such as those including Teflon, nylon, or other polymer-based materials. Ideally, the tips are produced inexpensively and in such a quantity so as to sell cheaply as single-use items, e.g. by injection molding or automated machining from polyethylene, polypropylene, nylon, acrylonitrile-butadiene-styrene (ABS) or a like medically suitable polymer. In a preferred embodiment, the material of the tip 50 is made from a plastic selected for its durability during use, and also for deformation at conventional autoclave conditions. This prevents a single-use tip 50 from being re-used after the autoclave procedure, e.g. if the tip 50 is inadvertently left in place when the insert is sterilized. Alternatively, the plastic can include a thermochromic indicator that permanently changes the color of the tip 50 at a predetermined temperature to indicate an autoclave history.

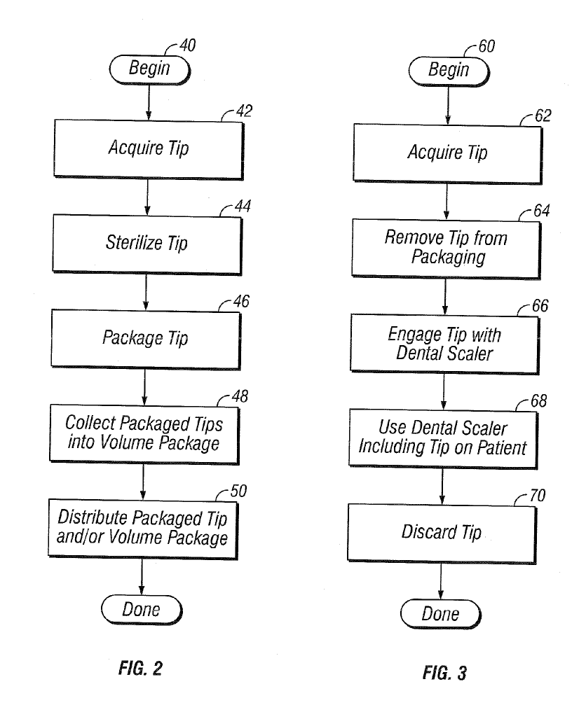

In FIG. 2, operations for supplying the disposable tip 50 are illustrated in a flow diagram, according to one embodiment. The operations depicted are preferably conducted during manufacture of the sterilized, packaged plastic tip 25. First, a specific make and model of ultrasonic dental handpiece insert is identified. Then, the plastic tip 50 is formed or otherwise acquired (block 40). Thereafter, the tip is packaged (block 42). In one embodiment, upon attachment to a dental handpiece insert, the distal end or the tip corresponds to a node of maximum vibration and the proximal end corresponds to an antinode.

In one embodiment, the packaging precedes sterilization. Any of a variety of packaging methods can be employed, such as vacuum packaging, shrink-wrap packaging, and so on. In particular, methods for packaging sterilizable medical equipment, such as hypodermic needles, operating room tools, and the like, are preferred for packaging the sterilized plastic tip 50.

After packaging, the tip is then sterilized, preferably not using autoclaving or other steam techniques, for the reasons specified above (block 44). Instead, for example, the plastic tip can be sterilized using conventional gas (e.g. ethylene oxide) or irradiation (gamma ray) sterilization techniques, or the like.

The packaging operation is preferably a low-cost technique, such that the retail price of the packaged sterilized tip is nominal. After sterilization the tips can be sold or distributed (block 46) to dental practitioners having at least one or more specific make and model of ultrasonic dental handpiece insert. In one embodiment, the packaged tips can be labeled to identify the specific make and model of dental handpiece insert. Additionally or alternatively, a list of compatible makes and models of inserts and/or dental scalers can be published, e.g. as an insert, as part of a catalogue, and/or online. Optionally, the packaged tip 50 can be grouped with other packaged tips, to be sold in quantity (block 46). Once packaged, the tip can be sold or distributed (block 46). Generally instructions for removing the tip from the packaging are provided.

In FIG. 3, operations for using the disposable tip 50 are illustrated, according to one embodiment. First, the plastic tip 50 is sold, distributed and shipped to or otherwise acquired by the dental professional (block 60). Preferably, the identification of at least one make and model of ultrasonic dental handpiece insert for which the supplied tip is suitable for use is provided to the dental practitioner. Ideally, the dental professional purchases the packaged tips in bulk. The tip is removed from the sealed packaging (block 62), preferably using sterile techniques. Generally, when connecting the components of a dental scaler together, the dental professional wears sterile gloves. Once removed from its packaging, the tip can be screwed or otherwise attached onto an insert for a handpiece of an ultrasonic scaler (block 64).

Once the tip 50 is engaged with the insert of the dental scaler, the dental scaler can be used in a well known manner. Particularly, though, patients with titanium implants are treated without concern about instrument autoclavability. Other portions of the dental scaler, such as the insert, continue to be sterilized between use by autoclave, as is already the practice in the dental office.

Thus, the dental scaler, with the disposable tip, is used on the patient (block 66). The disposable tip 50 is preferable to decalcify titanium implants but can also be used on the teeth of the patient. Once the dental procedure is complete, the disposable tip 50 is discarded, according to one embodiment (block 68).

The above description is only illustrative of embodiments of the invention. Various changes and modifications of these embodiments will occur to the skilled artisan in view of the preceding specification. It is intended that all such modifications and changes within the scope and spirit of the appended claims be embraced thereby.

1. A method for supplying dental practitioners with single-use tips for use with an insert for a handpiece in an ultrasonic dental scaler unit comprising:
identifying one or more specific make and model of ultrasonic dental scaler handpiece insert for which the tips will be supplied, wherein the inserts include a distal end adapted for removably attaching the tips;
forming a plurality of identical monolithic polymeric ultrasonic dental scaler tips for the one or more specific ultrasonic dental scaler handpiece insert, wherein the polymeric tips each have proximal and distal ends and the proximal end is removably attachable to the distal end of the specific insert;
individually packaging the polymeric tips in a sealed container;
sterilizing the packaged polymeric tips; and
distributing the sterilized, packaged polymeric tips to dental practitioners.

2. The method of claim 1, further comprising:
coupling the individually packaged sterilized polymeric tips with other individually packaged sterilized polymeric tips;
packaging the coupled tips as a quantity package; and
distributing the quantity package.

3. The method of claim 1, further comprising:
providing the dental practitioners with the one or more specific ultrasonic dental scaler handpiece insert.

4. The method of claim 1, further comprising:
labeling the packaged tips to identify the one or more specific make and model of ultrasonic dental scaler handpiece insert with which the tips are compatible.

5. The method of claim 1, further comprising:
publishing a list comprising the identification of the one or more specific make and model of ultrasonic dental scaler handpiece insert for which the packaged tips are compatible.

6. The method of claim 1, wherein the sealed container is a vacuum-sealed plastic packaging.

7. The method of claim 1, wherein the proximal end of the polymeric tip corresponds to an antinode and the distal end of the polymeric tip corresponds to a node, when the polymeric tip is attached to the one or more specific make and model of ultrasonic dental scaler handpiece insert.

8. The method of claim 1 wherein the polymeric tip comprises a polymer that deforms at autoclave conditions.

9. The method of claim 1 wherein the polymeric tip comprises a polymer that permanently changes color at autoclave conditions.

10. The method of claim 1, wherein the sealed container is sterilized by gas permeation.

11. The method of claim 1, wherein the sealed container is sterilized by irradiation.

12. A method for using a disposable tip with an ultrasonic dental scaler, comprising:
supplying a sterilized monolithic polymeric ultrasonic dental scaler tip in a sealed container to a dental practitioner according to claim 1;
providing the dental practitioner with the identification of the at least one make and model for which the supplied tip is suitable for use;
providing the dental practitioner with instructions for removing the tip from the packaging, attaching the tip to the dental insert corresponding to the one or more specifically identified make and model, securing the dental insert in a handpiece of an ultrasonic dental scaler, operating the dental scaler to clean titanium implants, disposing of the tip after the operation, or a combination thereof.

13. A method comprising:
acquiring a make and model of an ultrasonic dental scaler unit comprising a handpiece with an insert, the insert having a distal end adapted for removably attaching a dental scaler tip;
acquiring a plurality of identical pre-packaged, sterilized, monolithic polymeric ultrasonic dental scaler tips for the ultrasonic dental scaler unit;
removing one of the sterilized polymeric tips from the sealed container;
attaching the removed tip to the insert;
operating the ultrasonic dental scaler unit with the attached polymeric tip to clean the teeth of a patient, wherein the patient has titanium implants; and
thereafter disposing of the polymeric tip.

14. The method of claim 13, wherein the prepackaged tip is labeled for use with the specific make and model of the acquired ultrasonic dental scaler.

15. The method of claim 13, further comprising:
removing the used tip from the dental insert for the disposal;
thereafter sterilizing the dental insert; and
repeating said removal, attachment and operation with another one of the plurality of tips, the sterilized dental insert, and a different person.

16. The method of claim 13, wherein the sealed container is sterilized by gas permeation.

17. The method of claim 13, wherein the sealed container is sterilized by irradiation.

18. The method of claim 13, wherein the proximal end of the polymeric tip corresponds to an antinode and the distal end of the polymeric tip corresponds to a node, when the polymeric tip is attached to the insert of the specific make and model of ultrasonic dental scaler unit.

19. The method of claim 13, wherein operation of the ultrasonic dental scaler unit induces the attached polymeric tip to vibrate at a very high rate.
